(19) United States
(12) Patent Application Publication
(10) Pub. No.: US 2022/0242998 A1
(43) Pub. Date: Aug. 4, 2022

(54) IMPROVED THERMOPLASTIC POLYURETHANES

(71) Applicant: BASF SE, Ludwigshafen am Rhein (DE)

(72) Inventor: Mark D. Swartzlander, Wyandotte, MI (US)

(21) Appl. No.: 17/612,832

(22) PCT Filed: May 20, 2020
(86) PCT No.: PCT/US2020/033678

§ 371 Date: Nov. 19, 2021

Related U.S. Application Data
(60) Provisional application No. 62/850,095, filed on May 20, 2019.

(51) Int. Cl. C08G 18/32; C08G 18/66; C08G 18/48

(52) U.S. Cl. CPC C08G 18/3218; C08G 18/4854; C08G 18/6674

(57) ABSTRACT

Provided herein are novel thermoplastic polyurethanes having improved qualities such as reduced film haze and high transparency, together with methods for producing the same. The thermoplastic polyurethanes disclosed herein are obtainable or obtained by reaction of (i) at least one aliphatic polyisocyanate, (ii) at least one polyol, (iii) at least one chain extender, and (iv) a sorbitol-based clarifying agent, wherein a content of the sorbitol-based clarifying agent is predetermined relative to a total weight of the components (i) to (iii).

### FIELD OF THE INVENTION

The present disclosure generally relates to novel thermoplastic polyurethanes having reduced film haze, high transparency and methods for producing the same. The thermoplastic polyurethanes described herein are obtainable or obtained by reaction of (i) at least one aliphatic polyisocyanate, (ii) at least one polyol, (iii) at least one chain extender, and (iv) a sorbitol-based clarifying agent, wherein the content of the sorbitol-based clarifying agent is predetermined, approximately from about 0.1 to 10.0 weight % relative to a total weight of the components (i) to (iii).

### BACKGROUND OF THE INVENTION

Thermoplastic polyurethanes, also known as TPUs, and methods for producing them are well known and have been diversely described.

Thermoplastic polyurethanes based on aliphatic isocyanates, in particular, have the advantage of particularly good lightfastness in that they are resistant to fading. These aliphatic thermoplastic polyurethanes, as they are termed, are increasingly finding application in the production of light-stable and colorfast moldings such as, for example, injection moldings of any form, films, tubing, cables, or sintered foils such as surfaces of instrument panels.

A major limitation of hexamethylene diisocyanate based TPUs however, is that they suffer from poor extrusion quality and poor optical quality, e.g., haze, due to lack of homogeneity in the film. Therefore, there is a need for TPUs with reduced film haze and high transparency and methods for producing the same. The present disclosure, is based on the object of providing TPUs with reduced film haze and high transparency.

### SUMMARY OF THE INVENTION

Provided herein are thermoplastic polyurethane compositions obtainable or obtained by the reaction of (i) at least one aliphatic polyisocyanate, (ii) at least one polyol, (iii) at least one chain extender, and (iv) a sorbitol-based clarifying agent, wherein a content of the sorbitol-based clarifying agent is predetermined, approximately from about 0.1 to 10.0, 0.1-8.0, 0.1-5.0, 0.1-3, or 0.1-0.8 weight % relative to a total weight of the components (i) to (iii).

Surprisingly, it has been found that the incorporation of the sorbitol-based clarifying agent into the polymer structure, not only does not impair the lightfastness of aliphatic thermoplastic polyurethanes, but it can be used to produce a TPU of high transparency and lightfastness. In addition, the crystallization temperature of the TPUs of the present disclosure are at least 45% higher than a TPU obtained with the same components but without the sorbitol-based clarifying agent. Though not wishing to be bound by the following theory, it was found that a higher crystallization temperature enabled crystallization to take place sooner when the material is cooling.

### DETAILED DESCRIPTION

Thermoplastic polyurethanes (TPUs) having improved properties such as decreased film haze and increased transparency, and methods for producing the same, are described herein. The resulting TPUs may be used for various applications, e.g., film and sheet applications in flooring and graphic films.

In embodiments, a thermoplastic polyurethane obtainable or obtained by reaction of (i) at least one aliphatic polyisocyanate, (ii) at least one polyol, (iii) at least one chain extender, and (iv) a sorbitol-based clarifying agent, wherein a content of the sorbitol-based clarifying agent is from about 0.1 to 0.8 weight % relative to a total weight of the components (i) to (iii) is provided.

Polyols are known in principle to the person skilled in the art and described, for example, in the “Plastics Handbook, volume 7, Polyurethanes”, Carl Hanser Verlag, 3rd edition 1993, chapter 3.1 (incorporated herein by reference in its entirety). Particular preference is given to using polyesterols or polyetherols as polyols. It is likewise possible to use polycarbonates. In the context of the present disclosure, it is also possible to use copolymers. The number-average molecular weight of the polyols used according to the disclosure comprises between approximately 0.5×10³ g/mol and 8×10³ g/mol, between approximately 0.6×10³ g/mol and 5×10³g/mol, in certain embodiments between approximately 0.8×10³g/mol and 3×10³ g/mol.

Accordingly, the present disclosure relates, according to a further embodiment, to a thermoplastic polyurethane as described above, where the at least one polyol comprises a polyol selected from the group consisting of polyetherols.

According to the disclosure, polyetherols comprise polyethylene glycols, polypropylene glycols and polytetrahydrofurans.

According to an embodiment, the polyol comprises a polytetrahydrofuran with a molecular weight in the Mn range from approximately 600 g/mol to 2500 g/mol.

Accordingly, the present disclosure relates, according to a further embodiment, to a thermoplastic polyurethane as described above, where the at least one polyol comprises a polyol selected from the group consisting of polytetrahydrofurans with a molecular weight Mn in the range from approximately 600 g/mol to 2500 g/mol.

As provided herein, the polyols used have an average functionality between 1.8 and 2.3, preferably between 1.9 and 2.2, in particular 2. In an embodiment, the polyols used according to the disclosure have only primary hydroxyl groups.

According to the disclosure, the polyols may be used in pure form or in the form of a composition comprising the polyol and at least one solvent. Suitable solvents are known to the person skilled in the art.

According to the disclosure, it is possible to use one or more chain extenders, it is also possible to use mixtures of different chain extenders.

Chain extenders used may comprise aliphatic, araliphatic, aromatic and/or cycloaliphatic compounds having a molecular weight of molecular weight of 50 g/mol to 220 g/mol, difunctional compounds, examples being diamines and/or alkanediols having 2 to 10 carbon atoms in the alkylene radical, di-, tri-, tetra-, penta-, hexa-, hepta-, octa-, nona- and/or decaalkylene glycols having 3 to 8 carbon atoms, especially 1,2-ethylene glycol, 1,3-propanediol, 1,4-butanediol, 1,5-pentanediol, 1,6-hexanediol, preferably corresponding oligopropylene and/or polypropylene glycols, and mixtures of the chain extenders can also be used. The chain extenders used have only primary hydroxyl groups.

In certain embodiments, the at least one chain extender is selected from the group consisting of 1,2-ethylene glycol, 1,3-propanediol, 1,4-butanediol, 1,5-pentanediol, and 1,6-hexanediol or any combination thereof.

According to a further embodiment, the chain extender may be selected from the group consisting of 1,4-butanediol and 1,6-hexanediol.

Sorbitol-based clarifying agents may be used to improve the qualities of the product, for example to enhance the aesthetic appeal of the formed product by making it more transparent, i.e., providing it with decreased haze and enhanced clarity.

One or more sorbitol-based enhancing agents appropriate for use herein maybe selected from a variety of suitable materials. Included are commercially available materials such as those sold by Milliken Chemical under the trade name MILLAD®. Examples of such products suitable for use in the present disclosure include MILLAD® 3988, a powdered sorbitol product, MILLAD® NX™ 8000 (1,2,3-trideoxy-4,6:5,7-bis-[(4-propylphenyl)methylene]-nonitol) and MILLAD® NX™ 8500E, both sorbitol -based clarifying agents. Derivatives of dibenzylidene sorbitol (DBS) may also be utilized, such as MDBS (1,3:2,4-di-p-methylbenzylidene sorbitol), EDBS, and DMDBS (bis (3,4-dimethylobenzylideno) sorbitol). Other examples include but are not limited to Irgaclear D ((1,3:2,4)-dibenzylidene sorbitol) and Irgaclear DM (1,3:2,4-Bis-(p-ethylbenzylidene) sorbitol) available from BASF. In an embodiment, the sorbitol-based clarifying agent comprises 1,2,3-trideoxy-4,6:5,7-bis-O-[(4-propylphenyl)methylene]-nonitol.

Aromatic tris amides, such as those commercially available as Irgaclear XT 386 and NJSTAR NU-100 (N,N′-dicyclohexyl-2,6-naphthalenendicarboxamide) had no positive effects on the properties of TPU. In this respect, the crystallization temperature for TPUs with such nucleating agents did not change relative to a TPU without the aromatic tris amide.

In some embodiments, the clarifying agent is present in an amount from about 0.1 wt. % to about 0.8 wt. % based on the total weight of the components (i) to (iii). In some embodiments, the clarifying agent is present in an amount from about 0.4 wt. % to about 0.6 wt. % based on the total weight of the components.

According to the disclosure, at least one aliphatic polyisocyanate is used. According to the disclosure, it is also possible to use mixtures of two or more aliphatic polyisocyanates.

In other embodiments, pre-reacted prepolymers maybe used as isocyanate components, in which some of the OH components are reacted with an isocyanate in an upstream reaction step. These prepolymers are reacted in a subsequent step, the actual polymer reaction, with the remaining OH components and then form the thermoplastic polyurethane. The use of prepolymers offers the possibility of also using OH components with secondary alcohol groups.

The at least one aliphatic diisocyanate used comprises customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or 1-methyl-2,6-cyclohexane diisocyanate, 4,4′-, 2,4′- and/or 2,2′-methylenedicyclohexyl diisocyanate (H12MDI).

In certain embodiments aliphatic polyisocyanates used herein comprise hexamethylene 1,6-diisocyanate (HDI), 1-isocyanato-3,3,5-trimethyl-5-isocyanatomethylcyclohexane and 4,4′-, 2,4′- and/or 2,2′-methylenedicyclohexyl diisocyanate (H12MDI); as well as 4,4′-, 2,4′- and/or 2,2′-methylenedicyclohexyl diisocyanate (H12MDI) and 1-isocyanato-3,3,5-trimethyl-5-isocyanatomethylcyclohexane or mixtures thereof.

The polyisocyanate can be used in pure form or in the form of a composition comprising the polyisocyanate and at least one solvent. Suitable solvents are known to the person skilled in the art. Of suitability are, for example, nonreactive solvents such as ethyl acetate, methyl ethyl ketone and hydrocarbons.

During the reaction of the at least one aliphatic polyisocyanate; the at least one chain extender; and the at least one polyol, further feed materials can be added, for example catalysts or auxiliaries and additives. Suitable auxiliaries and additives are known to the person skilled in the art. Such materials may include, for example, surface-active substances, flame retardants, nucleating agents, oxidation stabilizers, antioxidants, lubrication and mold release aids, dyes and pigments, stabilizers, e.g. against hydrolysis, light, heat or discoloration, inorganic and/or organic fillers, reinforcing agents and plasticizers. Suitable auxiliaries and additives can be found, for example, in the Kunststoffhandbuch [Plastics Handbook], volume VII, published by Vieweg and Höchtlen, Carl Hanser Verlag, Munich 1966 (pp. 103-113).

Suitable catalysts are likewise known from the prior art. Suitable catalysts comprise, for example, organic metal compounds selected from the group consisting of tin, titanium, zirconium, hafnium, bismuth, zinc, aluminum and iron organyls, such as, for example, tin organyl compounds, preferably tin dialkyls such as tinII isooctoate, tin dioctoate, dimethyltin or diethyltin, or tin organyl compounds of aliphatic carboxylic acids, tin diacetate, tin dilaurate, dibutyltin diacetate, dibutyltin dilaurate, titanic acid esters, bismuth compounds, such as bismuth alkyl compounds, preferably bismuth neodecanoate or the like, or iron compounds, such as iron-(MI) acetylacetonate.

According to an embodiment, the catalysts used herein are selected from tin compounds and bismuth compounds, such as tinalkyl compounds or bismuthalkyl compounds. Of particular suitability are tin (II) isooctoate and bismuth neodecanoate.

The catalysts may be used in amounts of from 3 ppm to 2000 ppm, 10 ppm to 1000 ppm, 20 ppm to 500 ppm and from 30 ppm to 300 ppm.

The disclosure further is related to a method of manufacturing a thermoplastic polyurethane having improved mechanical qualities, comprising the reaction of (i) at least one aliphatic polyisocyanate; (ii) at least one polyol; (iii) at least one chain extender; and (iv) a sorbitol-based clarifying agent. The content of the sorbitol-based clarifying agent is from about 0.1 to 0.8 weight % relative to a total weight of the components (i) to (iii).

The process can in principle be carried out under reaction conditions known to those skilled in the art. The preparation of thermoplastic polyurethanes according to the invention is carried out batchwise or continuously by known methods, using reaction extruders or the belt process by the one-shot process or the prepolymer process. In this process, the components to be reacted may be mixed with one another in succession or simultaneously, with the reaction commencing immediately. In the extruder process, the formative components are introduced individually or as a mixture into the extruder, reacted at temperatures of preferably from 100° C. to 280° C., or from 140° C. to 250° C., and the polyurethane obtained is extruded.

According to an embodiment, the process is carried out under higher temperatures than room temperature, generally in a range between 50° C. and 200° C., from 65° C. to 150° C., or from 75° C. to 120° C.

According to the disclosure, a heating step may take place in any suitable manner known to the person skilled in the art, preferably by electrical heating, heating via heated oil or water, induction fields, warm air or IR radiation.

The examples below serve to illustrate the invention but are in no way limiting as regards the subject matter of the present invention.

### EXAMPLES

The following feed materials were used:
Polyol: Polytetrahydrofuran; (1000 g/mol)
Isocyanate: hexamethylene 1,6-diisocyanate (HDI);
Chain Extender: 1,6-hexanediol;
Sorbitol-based clarifying agent: 1,2,3-trideoxy-4,6:5,7-bis-O-[(4-propylphenyl)methylene]-nonitol.

In certain embodiments, the isocyanate component comprises approximately 20-40wt %, the polyol comprises approximately 35-75wt %, and the chain extender comprises approximately 5-25%.

All compositions and mixtures according to the disclosure and also the comparative sample of the thermoplastic polyurethanes (TPUs) were produced by the “one-shot” process on a reaction extruder. Here, all constituents of the composition were introduced into the reaction extruder.

The production of the compositions and mixtures was carried out on a commercial twin-screw extruder, here a Coperion ZSK, at the process temperatures of from 160° C. to 240° C. customary for TPU, as described in EP 1846465 or EP1213307 (incorporated herein by reference). The amounts of the individual constituents are reported as parts by weight (pbw).

TABLE I

| | | | | | | |
|---|---|---|---|---|---|---|
| 1,6-HDO % | 7.24 | 7.23 | 7.22 | 7.21 | 7.18 | 7.12 |
| PTHF 1000% | 70.59 | 70.52 | 70.45 | 70.30 | 70.02 | 69.46 |
| Iso (%) | 22.17 | 22.15 | 22.13 | 22.09 | 22.00 | 21.82 |
| Millad NX 8000 | — | 0.10 | 0.20 | 0.40 | 0.80 | 1.60 |
| (clarifying | | | | | | |
| agent) % | | | | | | |

Crystallization Temperature

The crystallization temperature was determined by the ASTM E1356 heat/cool/heat method from −80° C. to 250° C. at a heating rate of 20° C./min.

Determination of the Transmission/Opacity

The transmission or opacity was measured once using a light trap as background and once using a white tile as background in reflection with the exclusion of gloss using a colorimeter. The lightness values (L value in accordance with DIN 6174) are compared and given as opacity in %.

An “UltraScan” colorimeter from HunterLab was used. The samples are produced in accordance with AA E-10-132-002. The colorimeter is standardized upon reaching the operating temperature, generally 30 minutes, and run under the following parameters:

Mode: RSEX (Reflection Specular Excluded), reflection without gloss, with opening of the gloss trap

Area view: large

Port size: 25.4

UV filter: out

The total opacity is calculated according to the following formula:

Opacity=(L value−black/L value−white)×100%.

According to this, an opacity value of 0% means complete transparency (100%) of the sample and a value of 100% opacity means complete nontransparency (transparency=0%).

The results are summarized below.

TABLE II

| Sample | Tcryst (° C.) |
|---|---|
| A1185 Control | 33 |
| 0.1% NX8000 | 48 |
| 0.2% NX8000 | 53 |
| 0.4% NX8000 | 61 |
| 0.8% NX8000 | 60 |
| 1.6% NX8000 | 64 |

As shown in Table II, samples produced with an added concentration of 0.1 wt % to 0.8% of a sorbitol-based clarifying agent improved the transparency of the film relative to the control sample that was produced without any added concentration of a clarity agent. Accordingly samples produced with an added concentration of 0.1 wt % to 0.8% of a sorbitol-based clarifying agent demonstrated an improved film quality. On the other hand, the sample produced with an added concentration of 1.6 wt % of the sorbitol-based clarifying agent demonstrated poor film quality (nibs). Samples produced with an added concentration of 0.4 wt % to 0.6 wt % of the sorbitol-based clarifying agent demonstrated the best film quality.

In addition, the control sample that was produced without any added concentration of the clarity agent exhibited a crystallization temperature of 33° C. The sample produced with only an added concentration of 0.1 wt % of the clarity agent exhibited a crystallization temperature of48° C., resulting in approximately 45% increase in the crystallization temperature relative to the control sample. Examples 2-5 having a greater concentration of the clarity agent than Example 1 demonstrated an even higher crystallization temperature.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges maybe further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described herein in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described within the scope of the appended claims. The subject matter of all combinations of independent and dependent claims, both single and multiple dependent, is herein expressly contemplated.

1. A thermoplastic polyurethane comprising:
(i) at least one aliphatic polyisocyanate;
(ii) at least one polyol;
(iii) at least one chain extender; and
(iv) a sorbitol-based clarifying agent,
wherein a content of the sorbitol-based clarifying agent is from about 0.1 to 0.8 weight % relative to a total weight of the components (i) to (iii).

2. The thermoplastic polyurethane according to claim 1, wherein a content of the sorbitol-based clarifying agent is from 0.4 to 0.6 weight % relative to a total weight of the components (i) to (iv).

3. The thermoplastic polyurethane according to claim 1, wherein the sorbitol-based clarifying agent comprises 1,2,3-trideoxy-4,6:5,7-bis-O-[(4-propylphenyl)methylene]-nonitol.

4. The thermoplastic polyurethane according to claim 1, wherein the at least one chain extender comprises an aliphatic, araliphatic, aromatic, and/or cycloaliphatic diol having a molecular weight of approximately 50 g/mol to 220 g/mol.

5. The thermoplastic polyurethane according to claim 1, wherein the at least one chain extender is selected from the group consisting of 1,2-ethylene glycol, 1,3-propanediol, 1,4-butanediol, 1,5-pentanediol, and 1,6-hexanediol.

6. The thermoplastic polyurethane according to claim 1, wherein the at least one chain extender comprises 1,6-hexanediol.

7. The thermoplastic polyurethane according to claim 1, wherein the at least one polyol comprises polyetherol.

8. The thermoplastic polyurethane according to claim 1, wherein the at least one polyol is selected from the group consisting of polyethylene glycol, polypropylene glycol, and/or polytetrahydrofuran.

9. The thermoplastic polyurethane according to claim 1, wherein the at least one polyol comprises polytetrahydrofuran with a molecular weight in the Mn range from 600 g/mol to 2500 g/mol.

10. The thermoplastic polyurethane according to claim 1, wherein the at least one aliphatic polyisocyanate is selected from the group consisting of hexamethylene 1,6-diisocyanate (HDI), 1-isocyanato-3,3,5-trimethyl-5-isocyanatomethylcyclohexane, 4,4′-, 2,4′- and/or 2,2′-methylenedicyclohexyl diisocyanate (H12MDI), isophorone diisocyanate (IPDI), pentamethylene diisocyanate (PDI), and cyclohexane diisocyanate (H₆XDI) or mixtures thereof.

11. The thermoplastic polyurethane according to claim 1, wherein the at least one aliphatic polyisocyanate is hexamethylene 1,6-diisocyanate (HDI).

12. The thermoplastic polyurethane according to claim 1, wherein the thermoplastic polyurethane has a crystallization temperature that is higher than a crystallization temperature of a thermoplastic polyurethane that is not obtained by reaction with the sorbitol-based clarifying agent by 15° C. or more.

13. An article comprising the thermoplastic polyurethane according to claim 1, having improved mechanical qualities.

14. The article of claim 13, wherein the improved mechanical qualities comprise high extrusion qualities, high optical qualities, increased transparency and decreased inhomogeneity.

15. The article of claim 13, wherein the article comprises graphic films or floor coverings.

16. A method of manufacturing a thermoplastic polyurethane having improved mechanical qualities, comprising the reaction of
(i) at least one aliphatic polyisocyanate;
(ii) at least one polyol;
(iii) at least one chain extender; and
(iv) a sorbitol-based clarifying agent.

17. The method of claim 16, wherein the content of the sorbitol-based clarifying agent is from about 0.1 to 0.8 weight % relative to a total weight of the components (i) to (iii).

18. The method of claim 16, wherein a content of the sorbitol-based clarifying agent is from 0.4 to 0.6 weight % relative to a total weight of the components (i) to (iv).

19. The method according to claim 16, wherein the sorbitol-based clarifying agent comprises 1,2,3-trideoxy-4,6:5,7-bis-O-[(4-propylphenyl)methylene]-nonitol.

20. The method of claim 16, wherein the improved mechanical qualities comprise high extrusion qualities, high optical qualities, increased transparency and decreased inhomogeneity.
